(19) United States
(12) Patent Application Publication
(10) Pub. No.: US 2002/0027665 A1
(43) Pub. Date: Mar. 7, 2002

(54) Optical filter and a method for producing the same

(76) Inventors: Hiroyuki Abe, Tokyo (JP); Yu Mimura, Tokyo (JP); Kazuyo Mizuno, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/841,896

(22) Filed: Apr. 25, 2001

(30) Foreign Application Priority Data
Apr. 27, 2000 (JP) 2000-127178

(51) Int. Cl. G01B 11/06

(52) U.S. Cl. 356/630; 359/580; 356/632

(57) ABSTRACT

An optical filter having a precise optical thickness is produced by controlling the optical thickness of the film formed on the product substrate precisely. The optical thickness of the film formed on the monitoring chip 2 and the data of the relation of this optical thickness to the reflectance of the film are determined beforehand and used as film thickness control data. On arranging both the product substrate 3 and the monitoring chip 2 within the film forming area 7 to form films on these substrates simultaneously, the correction coefficient for correcting the amount of deviation of the optical thickness of the film formed on the product substrate 3 from the optical thickness of the film formed on the monitoring chip 2 is provided by the film thickness correction coefficient data determined beforehand, for example for each film material and according to the monitor light wavelength. When the film for product use is formed on the product substrate 3, the monitoring chip 2 is also formed a film simultaneously for measuring the reflectance of the film on the monitoring chip 2 and the film forming is stopped when the measured value reaches the reflectance of the aforementioned film thickness control data corresponding to the optical thickness corrected by the film thickness correction coefficient.

### FIELD OF THE INVENTION

The present invention relates to an optical filter and a method for producing the same.

### BACKGROUND OF THE INVENTION

An optical filter such as wavelength selective transmission filter (bandpass filter) or the like that passes only light having a predetermined waveband among the light input to the filter is widely used for optical communications use.

As a method for producing a optical filter of this kind, a method for forming a filtering film on a substrate by means of vacuum evaporation method, sputtering method etc. is used. The film thickness control of these film forming methods is generally executed by measuring the optical thickness of the film formed on the substrate with the use of an optical thickness meter.

### SUMMARY OF THE INVENTION

The present invention is proposed to provide a method for producing a desired optical filter and an optical filter formed by said method for producing, said method for producing optical filter comprising the steps of:

determining beforehand for each film material at least one of the following monitor characteristics: (1) reflectance or (2) transmittance of the monitor light irradiated onto the film formed on the monitoring chip and the data of the relation of said characteristic with the formed optical thickness and storing them as film thickness control data;

on the other hand, on arranging a product substrate and said monitoring chip respectively within a film forming apparatus thereby forming a film simultaneously on these substrates, providing film thickness correction coefficients corresponding to each monitor light wavelength and correcting the amount of deviation of the thickness of the optical film formed on said product substrate from the thickness of the optical film formed on the monitoring chip as film thickness correction coefficient data;

measuring said monitor characteristics by irradiating said monitor light onto the film formed on said monitoring chip having installed the product substrate and said monitoring chip respectively within said film forming apparatus and while forming a film simultaneously on these substrates; and

controlling the thickness of the film for product use formed on said product substrate, based on the monitor characteristics in said film thickness control data corrected by the film thickness correction coefficient corresponding to the used monitor light wavelength and by the above measured values, wherein:

said film thickness correction coefficient data is provided for each film forming material and the film thickness correction coefficient is changed according to the film forming material and the wavelength of the monitor light for use.

### BRIEF DESCRIPTION OF THE DRAWINGS

Exemplary embodiments of the invention will now be described in conjunction with drawings in which:

FIG. 1 is a block diagram showing schematically the vacuum evaporation apparatus equipped with an optical thickness meter as one example of the apparatus for producing optical filter;

FIGS. 2A and 2B are the drawings explaining an example of installation of a monitoring chip and a product substrate in case of forming a film on the monitoring chip and the product substrate by a vacuum evaporation apparatus applying the method for producing optical filter of the first embodiment according to the present invention;

FIG. 3 is a graph showing an example of the relationship between the thickness of the optical film on the monitoring chip and the thickness of the optical film on the product substrate in case of controlling the thickness of the optical film on the product substrate while irradiating respectively a plurality of monitor lights having different wavelengths from each other on the monitoring chip;

FIG. 4 is a graph showing one example of the film thickness correction coefficient used in an embodiment of the method for producing optical filter according to the present invention;

FIG. 5 is a cross-sectional illustration showing the condition in which a film 1 having an optical thickness of n₁d on a substrate having a refractive index of n₈ in a medium having a refractive index of n₀;

FIG. 6 is a graph showing the relationship between the optical thickness of the film formed on the monitoring chip and the monitor light reflectance obtained in case of irradiating a monitor light having a wavelength of film design reference on the film;

FIG. 7 is a graph showing the relationship between the optical thickness of the film formed on the monitoring chip and the monitor light reflectance obtained by irradiating monitor lights of different wavelength respectively on the film; and

FIG. 8 is a graph showing an example of the relationship between the thickness of the optical film on the monitoring chip and the thickness of the optical film on the product substrate when controlling the thickness of the optical film on the product substrate while irradiating a monitor light of a certain wavelength on the monitoring chip.

### DETAILED DESCRIPTION OF THE INVENTION

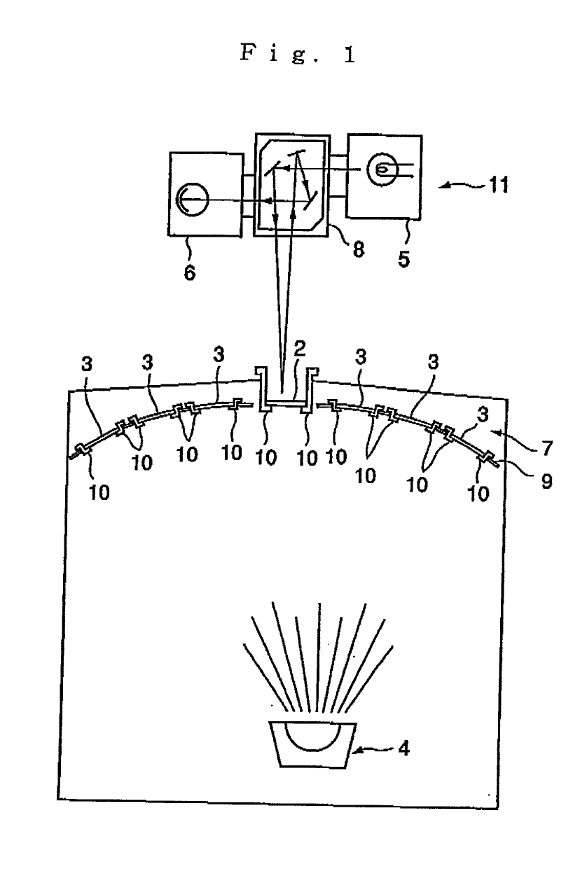

In FIG. 1, an example of a vacuum evaporation apparatus as a film forming apparatus equipped with an optical thickness meter 11 is shown in outline. In the apparatus shown in FIG. 1, a plurality of perforations of a dome shaped substrate holder 9 within the forming area 7 of the vacuum evaporation method is mounted with substrate holding members 10. A monitoring chip 2 and product substrates 3 are each installed on these substrate holding members 10. In addition, an evaporation source 4 is installed below the substrate holder 9. The inside of the forming area is shown in cross-sectional view in FIG. 1.

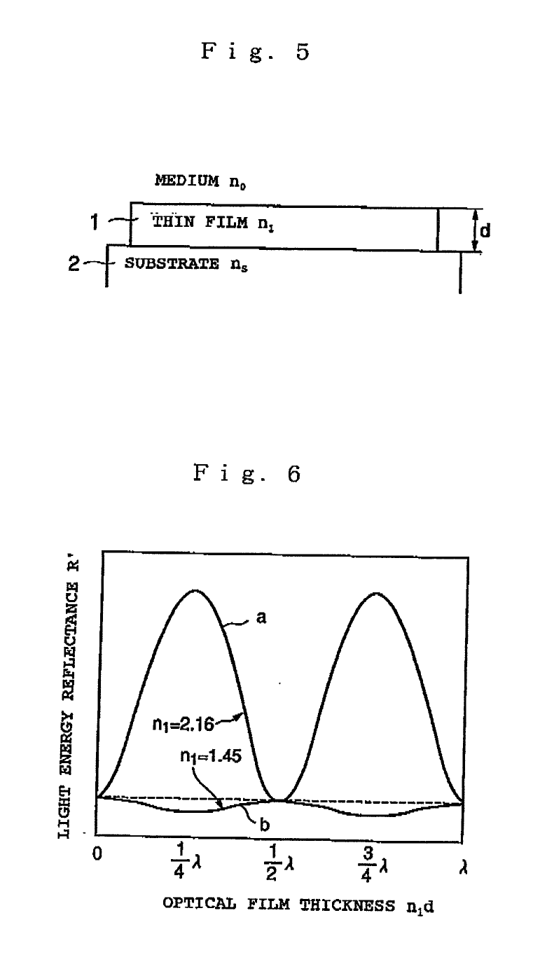

Further, an operation unit not shown is provided in the apparatus. Driving the apparatus by operating the operation unit, the material evaporated from the evaporation source 4 is adhered to the product substrate 3 and a film of the same film material (thin film) 1 is formed as shown in FIG. 5. For example, forming films with the material of the evaporation source 4 exchanged after the formation of each film 1, an optical filter having a multilayer film made of laminated films 1 of different film materials is produced.

The optical thickness meter 11 comprises a light source 5 irradiating a monitor light and a measuring apparatus 6 measuring either the reflectance or the transmittance of the monitor light, or both of these monitor characteristics. The measuring apparatus 6 shown in FIG. 1 is composed of an apparatus measuring the reflectance of the monitor light but it may also be the one measuring the light transmittance. The optical thickness meter 11 is provided with optical coupling means 8. This optical coupling means 8 is provided between the light source 5 and the measuring apparatus 6 so that monitor light output from the light source 5 onto the monitoring chip 2 and reflected from the monitoring chip 2 is coupled with the measuring device 6.

In this optical thickness meter 11, in case of irradiating the monitor light from the light source 5 to the monitoring chip 2, the reflectance (or the transmittance) varies as the film thickness formed on the monitoring chip 12 increases. The reflectance (or the transmittance) is measured by the measuring apparatus 6.

The relationship between the reflectance (or the transmittance) and the film thickness can be determined by a calculation. For example, as shown in FIG. 5, in the case of forming a film having a refractive index n₀, of geometrical thickness d on a substrate having a refractive index nₛ in the medium having a refractive index n₀, the aforementioned reflectance R is expressed by equation 1 taking the multiple reflection and the interference into consideration. In the equation 1, δ is given by the equation 2 wherein the wavelength of the input light (monitor light) is expressed as λ.

$$\begin{matrix}R = 1 - \frac{4 {n}_{0} {n}_{1}^{2} {n}_{s}}{{{n}_{1}^{2} ( {n}_{0} + {n}_{s} )}^{2} + ( {n}_{0}^{2} - {n}_{1}^{2} ) ( {n}_{s}^{2} - {n}_{1}^{2} ) {sin }^{2} δ} & ( 1 ) \\ δ = \frac{2 π}{λ} {n}_{1} d & ( 2 )\end{matrix}$$

In equation 1, the reflection from the rear of the substrate to be formed a film is not taken into consideration but in case that the substrate is polished on both sides, the reflection from the rear of the substrate to be formed a film also needs to be taken into consideration. Expressing the reflectance of the light from the rear of the substrate to be formed a film Ro, Ro is expressed by the equation 3. Therefore, the reflectance R′ considering the reflectance from the rear of the substrate on which a film is to be formed is expressed by the equation 4.

$$\begin{matrix}{R}_{0} = {( \frac{{n}_{0} - {n}_{s}}{{n}_{0} + {n}_{s}} )}^{2} & ( 3 ) \\ {R}^{′} = \frac{{R}_{0} + R - 2 {R}_{0} R}{1 - {R}_{0} R} & ( 4 )\end{matrix}$$

As the substrate forming the optical filter such as a bandpass filter is in general polished on both sides, the relationship between the reflectance R′ and the optical thickness (e.g.,n₁d) can be determined based on the equations 1 to 4. The optical thickness means the product of a reflectance of the film and a geometrical thickness of the film concerned. The reflectance refers hereinafter to the reflectance R′ indicating the reflection from both sides of front and rear expressed in the equation 4.

Incidentally, in the practical production of the formed film, the wavelength of the monitor light (monitor light wavelength) is fixed and the data on the relation of the optical thickness of the film 1 to be formed and the reflectance R′ is determined beforehand as for example in the graph data given in FIG. 6, thereby providing a film thickness control data. And indeed, when the product substrate 3 is formed a film by a vacuum evaporation apparatus shown in FIG. 1, the film thickness of the film 1 is controlled by a successive comparison between the aforementioned reflectance R′ changing in accordance with the formation of the film on the monitoring chip 2 measured by the optical thickness meter 11 and the aforementioned film thickness control data.

As is well known, the optical thickness of each film 1 formed for the production of an optical filter is designed to have the thickness equal to a reference wavelength prescribed for the design of the film thickness, the so called central wavelength, multiplied by a predetermined number. For many of the optical filters, the optical filter thickness of a film 1 is often set about 0.25 times (one fourth of) the central wavelength.

In FIG. 6, an example of the data on the relation of the reflectance R′ and the optical thickness n₁d is shown wherein the wavelength λ of the monitor light is determined to be the aforementioned central wavelength λ_{c}. The related data shown in FIG. 6 is the data determined by means of a simulation of the relationship between the variation of the reflectance R′ and the optical thickness n₁d in case of forming a film on a substrate of nₛ=1.50 in the medium (air) of n₀=1.00. In the drawing, the function line a shows the variation of the reflectance R′ in case of forming a filmhaving refractive index n₁=2.16 and the function line b shows the variation of the reflectance R′ in case of forming a film having refractive index n₁=1.45 respectively.

As is obvious from FIG. 6, in case of using central wavelength of λ_{c} as the monitor light wavelength λ, by stopping the film forming at the peak of the reflectance, a film having an optical thickness of ¼ λ_{c} can be formed.

However, the variation in the reflectance R′ near the peak of reflectance R′ is gentle so that it is difficult to determine correctly during the measurement of the monitor characteristics the point where in the monitor characteristics measured successively by the optical thickness meter 11 the reflectance R′ reaches near the peak. Therefore, it is difficult to stop forming the film precisely at the time when the reflectance R′ reaches its peak.

In addition, as mentioned above, because the variation of the reflectance R′ near the peak of the reflectance R′ is gentle, in case that the film forming is stopped before the reflectance R′ reaches the peak, the error Δ(n₁d) of the optical thickness of the formed film 1 becomes seriously large despite the error ΔR between the energy reflectance R′ at the time when the film forming is stopped (Q) and the peak point P of the energy reflectance R′ being small.

Therefore, by using a wavelength smaller than λ_{c}as the monitor light wavelength instead of using a central wavelength λ_{c} as the aforementioned monitor light wavelength λ, the cycle length of the reflectance R′ can be reduced as shown by, for example, the function line c in FIG. 7. Hereby, reducing the error Δ (n₁d) of the optical thickness corresponding to the error ΔR of the reflectance R′, it is made possible to control the optical thickness of the film 1. Incidentally, in case of deciding the monitor light wavelength, it is preferable to decide on a wavelength λ such that in the optical thickness of the formed film 1, for example, the error Δ (n₁d) of the optical thickness corresponding to the error AR of the reflectance R′ is reduced to be as small as possible.

Thus, the monitor light wavelength is set to be λ and in case of the wavelength λ being different from the aforementioned central wavelength λ_{c}, δ in the aforementioned equation 1 is given by the equation 5 instead of the aforementioned equation 2. In the equation 5, n₀ is the refractive index of the film 1 in case that the monitor light wavelength λ is the central wavelength λ_{c}.

$$δ = 2 π \times \frac{{n}_{c} d}{{λ}_{c}} \times {λ}_{c} \times \frac{1}{λ} \times \frac{{n}_{1}}{{n}_{c}} \qquad ( 5 )$$

In addition, as the refractive index n(n₁) of the film with respect to the monitor light wavelength is expressed by the equation 6, the refractive index n₁ also differs in case that the monitor light wavelength λ differs. Therefore, in case of setting the monitor light wavelength different from the central wavelength λ_{c}, the refractive index n₁ takes a value different from that of the refractive index n_{c} corresponding to the central wavelength λ_{c}. In addition, in the equation 6, A, B and C each differ according to the material composing the film 1 and all of them are determined from a well known experiment for determining the refractive index.

$$n = A + \frac{B}{{λ}^{2}} + \frac{C}{{λ}^{4}} \qquad ( 6 )$$

By the way, in the actual film forming, the refractive index n₁ of the film 1 fluctuates in accordance with the difference in the amount of flying particles accumulating in one position due to the difference of the installing position of the monitoring chip 2 and the product substrate 3, the difference of the ion current density in case of ion assisting during the film formation (during the ion assisted film formation), the fluctuation of the physical property values of the film 1 due to the difference in temperature or atmosphere before and after the film forming or etc. Therefore, the optical thickness of the film 1 differs between the one on the monitoring chip 2 and the one on the product substrate 3.

Hence, when forming a product film on the product substrate 3 to produce an optical filter, the product substrate 3 and the aforementioned monitoring chip 2 are each installed within the aforementioned film forming area 7. Then, while forming a film simultaneously on these substrates 2, 3, the aforementioned monitor light is irradiated on the film 1 formed on the substrate 2 so as to measure the reflectance R′. The film forming is stopped when the reflectance R′ reaches a value corresponding to the value of a certain optical thickness determined from the design (specification) of the film 1 multiplied by the film thickness correction coefficient determined beforehand, the optical thickness thereby being controlled.

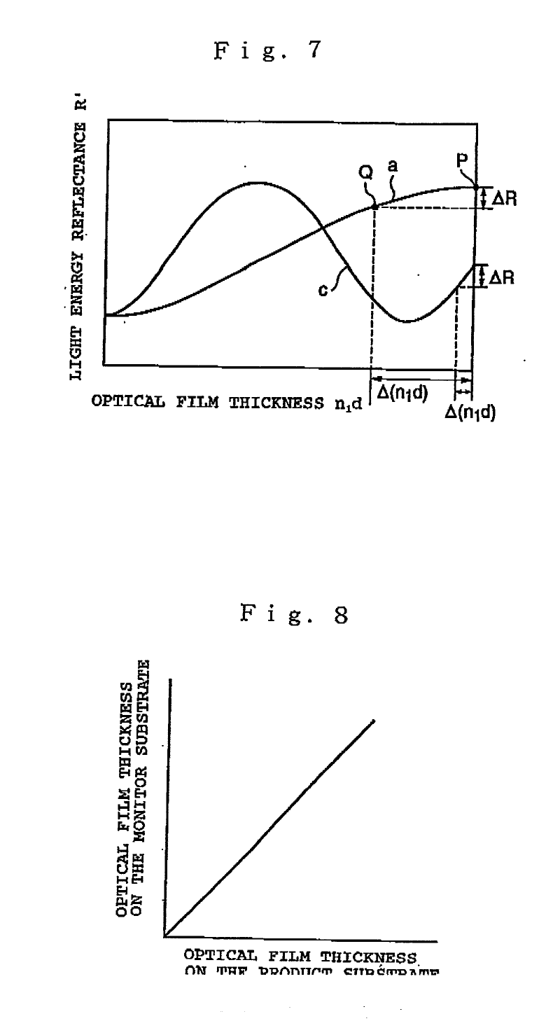

According to the conventional way of determining the aforementioned film thickness correction coefficient, only one monitor light wavelength is set at first and a film 1 is formed on the monitoring chip 2 and product substrate 3 while monitoring the film thickness of the film 1 formed on the monitoring chip 2 by the set monitor light wavelength. Then, from the relationship between the result of the aforementioned monitoring and the optical thickness of the film 1 formed on the product substrate 3, in case that the optical thickness on the product substrate 3 is proportional to the optical thickness on the monitoring chip 2 as shown, for example in FIG. 8, the gradient of the straight line in FIG. 8 is set as the film thickness correction coefficient.

In addition, in the prior art, the film thickness correction coefficient determined in the aforementioned way is regarded as constant regardless of the value of the monitor light wavelength and so the optical thickness control is executed using the same film thickness correction coefficient as described above even though any value of the monitor light wavelength may be used.

The inventor of the present application had doubts about this matter and has carried out an verification experiment, and found that the film thickness correction coefficient determined in the aforementioned way is not constant regardless of the value of the monitor light wavelength and that, for example as shown in FIG. 3, the film thickness correction coefficient (the gradient of each characteristic line in FIG. 3) differs according to the value of the monitor light wavelength (λ₀,λ₁, λ₂ in FIG. 3). The reason is thought for instance to lie in the difference between the amount of the fluctuation of the physical property constant of the film 1 according to the value of the monitor light wavelength. This is due to ,for example , that the chromatic dispersion of the refractive index of film 1 changes with the temperature, so that when the temperature of film 1 lowers from that at time of formation of the film to room temperature ,the amount of fluctuation of refraction index of film 1 differs according to the monitor light wavelength .

Therefore, like in the prior art, in case of controlling the optical thickness of the film 1 using the film thickness correction coefficient determined by single monitor light wavelength despite a plurality of monitor lights having a different wavelength from each other being used, the control of the optical thickness of the film formed using the different monitor light wavelength is not possible so that it was difficult to make the optical thickness formed by the film 1 with a correct value. Particularly, for the production of a multilayer optical filter using different film forming materials, in case of changing the monitor light wavelength each time when the film forming material is changed, with the use of film thickness correction coefficient determined according to one specific monitor light wavelength like in the prior art, the precise control of the optical thickness of the film 1 to be formed is impossible so that the quality of the multilayer optical filter (bandpass filter) cannot be improved.

The present invention provides in an embodiment a method for forming a film of an optical filter capable of forming a precise optical thickness in such way that the optical thickness of the film to be formed is controlled precisely to have a predetermined optical thickness, and at the same time provides an optical filter produced by said method for producing an optical film of a precise thickness.

Now, the embodiment as one aspect of the present invention is explained with reference to the drawings. An embodiment of the method for producing optical filter according to the present invention is a method for producing an optical filter using vacuum evaporation apparatus equipped with an optical thickness meter 11. The optical filter produced in this embodiment is a bandpass filter (BPF) of a multilayer filtering film formed, for example, of seven layers of film on the product substrate 3. The seven layers of film is formed, for example, by laminating H, L, H, 4L, H, L, and H sequentially on the substrate, wherein the layer H is formed of Ta₂O₅ with an optical thickness of a quarter of the central wavelength (here, 1470 nm), the layer L is formed of SiO₂ with an optical thickness of a quarter of central wavelength and the layer 4L is formed of SiO₂ with an optical thickness equal to the central wavelength.

In the present embodiment also like in the prior art, the aforementioned film thickness control data is determined beforehand and the film thickness control of the film 1 to be formed is executed based on the film thickness control data and the reflectance of the monitor light detected by the optical thickness meter 11. According to the one embodiment of the present invention, the film thickness control of the formed film is executed using film thickness correction coefficient data which is not provided in the prior art.

In this embodiment, as for the film thickness correction coefficient data, the correcting coefficient data for correcting the amount of deviation of the optical thickness of the film formed on the product substrate 3 from the optical thickness of the film formed on the monitoring chip 2 is provided for each film material responding to a plurality of monitor lights having a wavelength different from each other, in case of forming the film simultaneously on the product substrate 3 and the monitoring chip 2 installed in the film forming apparatus.

In one embodiment, the film formation in order to determine the film thickness correction coefficient data is performed as follows. In one example, first of all, the film thickness correction coefficient corresponding to three types of the monitor light wavelengths are determined for each film material (Ta₂O₅, SiO₂). In other words, for each layer of the film 1 composing the multilayer optical filter, measuring the thickness of the optical film 1 formed on the monitoring chip 2 using the monitor light wavelength of three types i.e. approximately 400 nm, approximately 490 nm and approximately 700 nm, the film 1 is formed simultaneously on the monitoring chip 2 and product substrate 3. Here, the monitoring chip 2 is exchanged for new one in each vapor deposition of a layer. Hereby, as the monitoring is performed by irradiating the monitor light directly always to the vapor deposited part of a single layer film, the optical thickness on the monitoring chip 2 can be controlled precisely. Incidentally, the product substrate 3 is not exchanged with every vapor deposition of a layer and it is formed by lamination of each layer of deposited film.

Next, after having formed the film, the transmittance of the aforementioned filter film (the filter film comprising the bandpass filter) of each layer formed on the product substrate 3 using the plurality of monitor light wavelengths different from each other (aforementioned three types of monitor light wavelength) is actually measured using light for measurement of film characteristics of a continuous range of wavelengths. Incidentally, as a matter of fact, the transmittance of the filtering film composing this bandpass filter can be measured indirectly by measuring the transmittance of the bandpass filter.

On the other hand, the theoretical value of the transmittance of the bandpass filter with respect to the a continuous range of wavelengths of the aforementioned light for measurement of film characteristics was determined based on the theoretical equation of the transmittance of the film in which the parameters of thickness of each layer of the film 1 are entered and on the design data. The theoretical equation of the light transmittance of the aforementioned film is given by the equation of the transmittance of the optical filter shown by the equation 7 and by the equations 8 to 10.

$$\begin{matrix}T = \frac{4 {n}_{0} {s}_{s}}{{( {n}_{0} {m}_{11} + {n}_{2} {m}_{22} )}^{2} {( {n}_{0} {n}_{s} {m}_{12} + {m}_{21} )}^{2}} & ( 7 ) \\ M = ( \begin{matrix}{m}_{11} & {im}_{12} \\ {im}_{21} & {m}_{22}\end{matrix} ) = {\prod }_{j = 1}^{7} {M}_{j} & ( 8 ) \\ {M}_{j} = ( \begin{matrix}cos {g}_{j} & i {n}_{j}^{- 1} sin {g}_{j} \\ {in}_{j} sin {g}_{j} & cos {g}_{j}\end{matrix} ) & ( 9 )\end{matrix}$$

gⱼ=2πnⱼdⱼλ⁻¹ (10)

Here, the parameters m₁₁, m₁₂, m₂₁, m₂₂ are each element of the characteristic matrix M at all layers given by the equation 8 and are given through the total multiplication of the characteristic matrix Mⱼ of each layer (from the first layer to the seventh layer) and the characteristic matrix Mⱼ of the No. j layer (j=1, 2, 3, 4, 5, 6, 7) is given by the equation 9, wherein gⱼ is given by equation (10), nⱼ is the refractive index of the No. j layer, and dⱼ is the geometrical thickness of the No. j layer. Then, using these equations 7 to 10 and substituting the design value of the optical thickness of the No. j layer into nⱼdⱼ, the theoretical value of the transmittance with respect to the continuous wavelength can be determined. Incidentally, in the equations 8, 9, i is an imaginary number.

For minimizing the square of the difference between the theoretical value of the transmittance determined as above and the actually measured value, the nonlinear fitting method is used and the appropriate value (the true value of nⱼd) of the optical thickness of each film layer is determined for each film material and for each of the aforementioned different monitor light wavelengths, these values set to be the optical thickness tₙ of the film formed on the product substrate.

In addition, the optical thickness of the film 1 formed on the monitoring chip 2 is measured using the monitor light wavelength of the aforementioned three type for each film material and the value is determined as the optical thickness tₘ of the film formed on the monitoring chip. Incidentally, because the film on the monitoring chip 2 is formed on the monitoring chip 2 to have thickness in accordance with the design (specification), the thickness of the optical film on the monitoring chip 2 equals the designed film thickness.

Further, tₘ/tₙ determined for each wavelength of monitor light and for every film material is decided as the film thickness correction coefficient corresponding to each monitor light wavelength. Incidentally, in this embodiment, as for the film forming by each monitor light wavelength, it is assumed that the optical thickness of the first, third, fifth and seventh layer made from Ta₂O₅ are all equal to each other, the optical thickness of the second and sixth layer made from SiO₂ are equal to each other and the film thickness of the fourth layer is four times as large as that, the film thickness correction coefficient corresponding to the aforementioned monitor light wavelength being determined thereby.

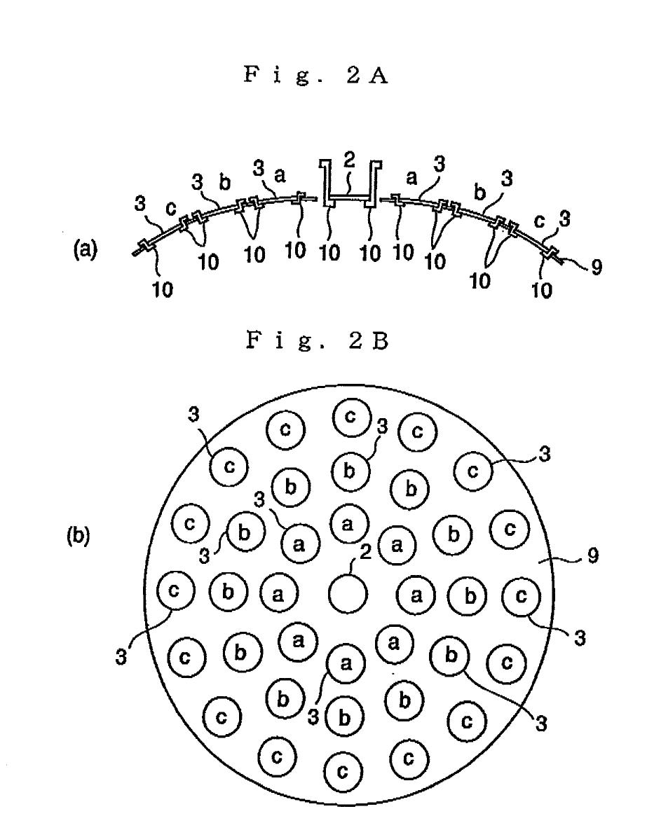

As mentioned above, the film thickness correction coefficient corresponding to each monitor light wavelength is determined and so different values are obtained according to the installation positions of the product substrate 3 i.e. installation positions a, b and c shown in FIGS. 2A, 2B. To be concrete, denoting those product substrates installed at a position a in FIGS. 2A, 2B as stage a, those installed at a position b as stage b and those installed at a position c as stage c, the results shown as follows are obtained.

As for Ta₂O₅ (layer H), the film thickness correction coefficient at each installation position with respect to the monitor light wavelength of 400 nmis 1.14423 (stage a), 1.13382 (stage b), 1.12988 (stage c), the film thickness correction coefficient at each installation position with respect to the monitor light wavelength of 490 nm is 1.14665 (stage a), 1.13802 (stage b), 1.13492 (stage c) and the film thickness correction coefficient at each installation position with respect to the monitor light wavelength of 700 nm is 1.15159 (stage a), 1.14260 (stage b), 1.13749 (stage c).

In addition, as for the SiO₂ (layer L), the film thickness correction coefficient at each installation position with respect to the monitor light wavelength of 400 nm is 1.14409 (stage a), 1.14248 (stage b), 1.13203 (stage c), the film thickness correction coefficient at each installation position with respect to the monitor light wavelength of 490 nm is 1.14782 (stage a), 1,14756 (stage b), 1. 13634 (stage c) and the film thickness correction coefficient at each position with respect to the monitor light wavelength of 700 nm is 1.14974 (stage a), 1.14916 (stage b), 1.13859 (stage c).

As described above, the film thickness correction coefficient for each monitor light wavelength differs according to the difference in the installation position of the product substrate 3. Among the product substrates 3, those concentrically centered around the monitoring chip 2 as described above were found to have a film thickness correction coefficients for the film 1 formed on the product substrate 3 that were approximately the same. Therefore, in this embodiment, the installation position of the product substrate 3 is set (stage b in this example) hereinafter, for the film forming being performed.

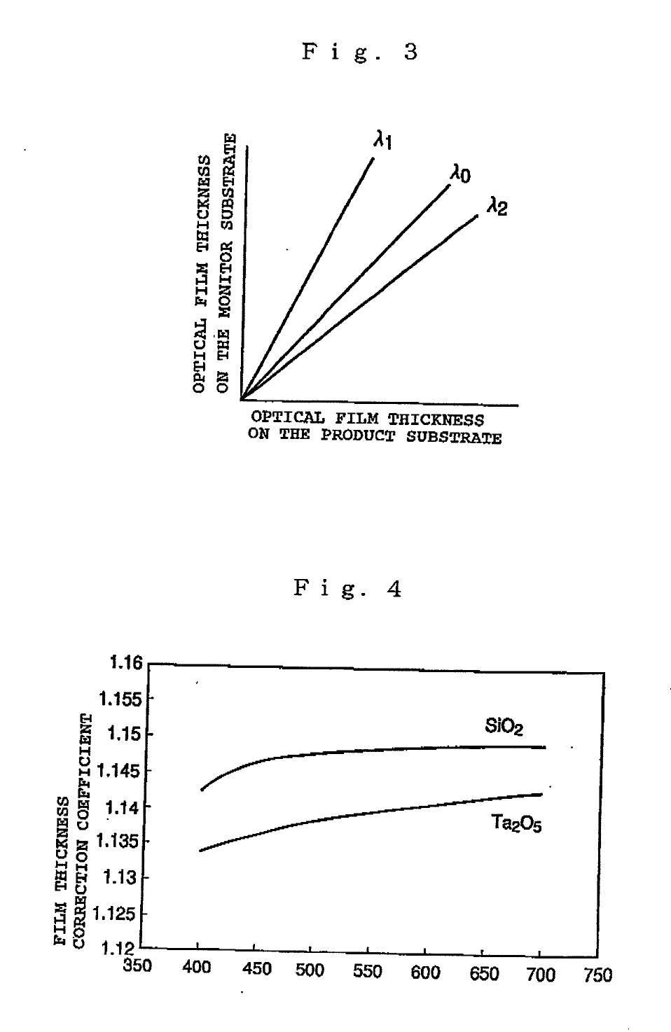

Here, in order to determine the film thickness correction coefficient data (the data of the relation of the film thickness correction coefficient to continuous monitor light wavelengths) based on the film thickness correction coefficient corresponding to each monitor light wavelength of the aforementioned sampling, in one embodiment, applying the aforementioned result to the polynomial equation 11 of the film thickness correction coefficient τ expressed as a function of the monitor light wavelength λ, the film thickness correction coefficient shown in FIG. 4 and Table 1 is obtained.

$$τ = E + \frac{G}{λ - F} \qquad ( 11 )$$

TABLE 1

| | Film thickness correction | Film thickness correction |
|---|---|---|
| Monitor wavelength | coefficient of Ta₂O₅ | coefficient of SiO₂ |
| 400 | 1.13382 | 1.14248 |
| 430 | 1.13550 | 1.14549 |
| 460 | 1.13688 | 1.14682 |
| 490 | 1.13802 | 1.14756 |
| 520 | 1.13898 | 1.14803 |
| 550 | 1.13980 | 1.14836 |
| 580 | 1.14051 | 1.14861 |
| 610 | 1.14113 | 1.14879 |
| 640 | 1.14168 | 1.14894 |
| 670 | 1.14216 | 1.14906 |
| 700 | 1.14260 | 1.14916 |

From the above result, E, F and G in the equation 11 are E=1.1503, F=136.82 and G=−4.3380 with respect to Ta₂O₅, and E=1.1502, F=353.15 and G =−0.3616 with respect to SiO₂.

In this way, by approximating the relationship between the monitor light wavelength λ and the film thickness correction coefficient r by a polynomial equation to determine the firm thickness correction coefficient data, the film thickness correction coefficient corresponding to the monitor light wavelength which is not determined by actual measurement can be determined from the film thickness correction coefficient data.

In this embodiment, as described above, from the film thickness correction coefficient determined with respect to three sampling monitor light wavelengths, the data of the relation of the film thickness correction coefficient to the continuous monitor light wavelengths as shown in FIG. 4 is determined as the film thickness correction coefficient data. Further, determining the reflectance in the aforementioned film thickness control data corresponding to the optical thickness corrected by the film thickness correction coefficient corresponding to the monitor light wavelength (reflectance corresponding to corrected film thickness), and when the reflectance measured by the optical thickness meter 11 equals the reflectance corresponding to the film thickness correction coefficient (corrected reflectance), formation of the film 1 is stopped.

As an example of this, a single layer film of Ta₂O₅, is formed on the product substrate 3 of the optical glass BK7. Incidentally, the monitoring chip 2 is also made from the optical glass BK7 like the product substrate 3 and the monitor light wavelength for forming the film is set 400 nm, while the central wavelength is set to be 1500 nm and the film forming is performed according to the design (specification) in which the optical thickness for this central wavelength is 0.25000.

In this case, as the film thickness correction coefficient for the monitor light wavelength of 400 nm is 1.13382 according to FIG. 4, a value 0.25000 multiplied by 1.13382 is set to be the optical thickness corrected by the film thickness correction coefficient. The reflectance is determined from the aforementioned film thickness control data corresponding to the corrected optical thickness (reflectance corresponding to corrected film thickness).

For example, by inserting the value 1.13382 multiplied by 0.25000 in the equation 5 and using the equations 1, 3, 4 to find the reflectance from the film thickness control data corresponding to the aforementioned corrected optical thickness (reflectance corresponding to corrected film thickness), 28.50% is obtained. Incidentally, the reflectance corresponding to corrected film thickness may also be obtained from the result of the simulation such as shown, in FIGS. 6, 7.

In addition, as is obvious from FIG. 7, in case that the value of the monitor light wavelength is set smaller than the aforementioned central wavelength, one or more reflection peaks pass before the optical thickness reaches one quarter of the central wavelength. Taking this fact into consideration, by providing, for example, for the number of the passing peaks as well as the reflectance corresponding to corrected film thickness in the aforementioned film thickness control unit, the film forming is controlled to be stopped when the reflectance reaches the reflectance corresponding to corrected film thickness (corrected reflectance) after having passed the specified number of peaks.

According to the one embodiment of the present invention, a bandpass filter as an optical filter is produced by laminating the film 1 on the product substrate 3, while controlling the optical thickness of the film 1 of each layer composing the optical filter as described above.

According to the one embodiment of the present invention, as described above, the film thickness correction coefficient data corresponding to the plurality of (or continuous) monitor light wavelengths is determined beforehand for each film material of the film 1 to be formed. Further, installing both the product substrate 3 and the monitoring chip 2 within the film forming area and forming the film simultaneously on these substrate 2, 3, the reflectance of the monitor light irradiated onto the film on the monitoring chip 2 is measured. On the other hand, the film thickness correction coefficient corresponding to the monitor light wavelength for use is determined from the film thickness correction coefficient data. Further, the film thickness of the formed film for product use formed on the product substrate 3 is controlled based on the measured value of the reflectance and the monitoring characteristics (reflectance in this example) of the aforementioned film thickness control data corresponding to the optical thickness corrected by the determined film thickness correction coefficient. Hereby, the optical thickness of the product film can be controlled precisely.

Particularly in producing the optical filter (bandpass filter) made of a multilayer film, as the film forming control is executed such that the monitor light wavelength is changed appropriately every time when the film forming material changes for a different film forming layer and the film thickness correction coefficient for use is also changed into the value appropriate for the monitor light wavelength and the film forming material in conjunction with the change of the monitor light, it is made possible to form the optical thickness of each layer in the bandpass filter formed on the product substrate precisely.

Therefore, the optical filter produced using the method for producing optical filter of the aforementioned embodiment can be made to be an optical filter that has an optical thickness just as designed.

Further, as an example as described above, the optical thickness of the film 1 of each layer formed on the product substrate 3 is determined by applying non-linear fitting method and the film thickness correction coefficient data for each film material of the film 1 is determined based on that determined value and further the film thickness correction coefficient corresponding to the monitor light wavelength is determined from the film thickness correction coefficient data. Therefore, the exactly appropriate film thickness correction coefficient for each film forming material and monitor light wavelength is applied so that the optical thickness of the film for product use can be controlled precisely in a high degree.

Incidentally, the present invention is not restricted to the aforementioned embodiment and various kinds of embodiments are available. For example, in the aforementioned embodiment, though the film thickness correction coefficients determined by a small sample of monitor light wavelengths is inserted in the polynomial equation 11 for determining the film thickness correction coefficient data corresponding to the continuous monitor light wavelengths and so is based on the film thickness correction coefficient determined for the aforementioned sample of monitor light wavelengths, the dependency of the film thickness correction coefficient on the wavelength may be approximated by a polynomial equation other than the equation 11 or the dependency of the film thickness correction coefficient on the wavelength may be approximated by a hyperbolic curve.

In any case, making the film thickness correction coefficient data into the data for the monitor light wavelength by approximating the wavelength dependency of the film thickness correction coefficient by the polynomial equation or hyperbolic curve, the film thickness correction coefficient corresponding to the monitor light wavelength, which had not yet been determined, may be determined easily from the film thickness correction coefficient data.

Further, in the above embodiment, though the appropriate optical thickness of the aforementioned film 1 is determined for the plurality of different light wavelengths and for each film material using the non-linear fitting method in order that the square of the difference between the theoretical value of the transmittance of the film 1 formed on the product substrate 3 and the measured actual value becomes minimum, and that determined value is assigned to the optical thickness of the film formed on the product substrate 3, the method for determining the optical thickness of the film formed on the product substrate 3 may be the one determined by a method other than those aforementioned.

For example, measuring the reflectance of the film 1 formed on the product substrate 3 actually, the appropriate value of the optical thickness of the aforementioned film 1 can be determined responding to the plurality of different optical wavelengths for each film material using the non-linear fitting method in order that the square of the difference between the measured actual value and the theoretical value of the reflectance is the minimum, or the optical thickness of the film 1 can be determined with the use of an approximating method other than the non-linear fitting method.

Further, in the aforementioned embodiment, though the monitor light is irradiated onto the film to form a film on the monitoring chip 2 with the use of the apparatus shown in FIG. 1 so that the reflectance is determined as a monitor characteristic, measuring the transmittance of the monitor light instead of the reflectance of the monitor light, the film thickness control data can be formed with the transmittance as the monitor characteristic.

In addition, the optical filter produced by the method for producing optical filter according to the present invention is produced by the film formed with the use of various film materials and so the film material or the optical thickness and the number of the layers are not restricted in particular and they are set appropriately.

What is claimed is:

1. A method for producing optical filter comprising the steps of:
determining beforehand for each film material at least one of the following monitor characteristics: (1) reflectance or (2) transmittance of the monitor light irradiated onto the film formed on the monitoring chip and the data of the relation of said characteristic with the formed optical thickness and storing them as film thickness control data;
and further, on arranging a product substrate and said monitoring chip respectively within a film forming apparatus thereby forming a film simultaneously on these substrates, providing the film thickness correction coefficient correcting the amount of deviation of the thickness of the optical film formed on said product substrate from the thickness of the optical film formed on the monitoring chip as film thickness correction coefficient data corresponding to each monitor light wavelength;
measuring said monitor characteristics by irradiating said monitor light onto the film formed on said monitoring chip having installed the product substrate and said monitoring chip respectively within said film forming apparatus and while forming a film simultaneously on these substrates; and
controlling the thickness of the film for product use formed on said product substrate based on said measured value and the monitor characteristics of said film thickness control data corrected by the film thickness correction coefficient corresponding to the used monitor light wavelength, wherein:
said film thickness correction coefficient data is provided for each film forming material and the film thickness correction coefficient is changed according to the film forming material and the wavelength of the monitor light for use.

2. The method for producing optical filter according to claim 1, wherein:
the film formed on the monitoring chip and the product substrate is a multilayer film laminated two or more kinds of different film forming materials; and
the wavelength of the monitor light is changed when the material of the layer formed is changed.

3. The method for producing optical filter according to claim 1, wherein said determining step of the film thickness correction coefficient data comprises:
actually measuring at least one of the following monitor characteristics: (1) reflectance or (2) transmittance of each film formed on the product substrate using a plurality of monitor light wavelengths different from each other by means of light for measurement of film characteristics having a continuous range of wavelengths;
determining the theoretical value of the same of the following monitor characteristics: (1) reflectance or (2) transmittance based on a theoretical equation with optical thickness as a parameter and on the design value of optical thickness, and using the values corresponding to the continuous range of wavelengths of the light for measurement of film characteristics;
determining the appropriate value of the optical thickness of said film for said monitor light wavelengths different from each other and for each film material, using a non-linear fitting method so as to minimize the square of the difference between said theoretical value and said actually measured value;
determining said determined value to be the optical thickness tₙ of the film formed on the product substrate;
further, measuring each optical thickness of the film formed on the monitoring chip simultaneously with the film formation on said product substrate using the plurality of monitor light wavelengths for each film material thereby assigning the measured value to be the optical thickness tₘ of the film formed on the monitoring chip;
determining tₘ/tₙ for each wavelength of the monitor light and for each film material to be the film thickness correction coefficient; and
determining the film thickness correction coefficient data to be data of the relation of the film thickness correction coefficient to the continuous range of monitor light wavelengths based on the determined film thickness correction coefficient corresponding to said each determined monitor light wavelength.

4. The method for producing an optical filter according to claim 3, wherein said film thickness correction coefficient data is a data obtained by approximating the dependency of the film thickness correction coefficient on the monitor light wavelength for certain monitor light wavelengths by a polynomial equation or a hyperbolic curve.

5. The method for producing an optical filter according to claim 1, wherein the film thickness control of a plurality of product substrates formed on the product substrate installed on the same circle centered around the monitoring chip is executed with the use of same film thickness correction coefficient.

6. An optical filter produced using the method for producing optical filter according to claim 1.
